(19) United States
(12) Patent Application Publication
(10) Pub. No.: US 2004/0062495 A1
(43) Pub. Date: Apr. 1, 2004

(54) Optical fiber product and method of fabricating thereof, Raman amplifier and method of fabricating thereof, method of fabricating of optical coupler, and optical transmission line

(75) Inventors: Tetsufumi Tsuzaki, Yokohama-shi (JP); Shinji Ishikawa, Yokohama-shi (JP)

Correspondence Address: MCDERMOTT WILL & EMERY, 600 13TH STREET, N.W., WASHINGTON, DC, 20005-3096, US

(73) Assignee: SUMITOMO ELECTRIC INDUSTRIES, LTD.

(21) Appl. No.: 10/670,201

(22) Filed: Sep. 26, 2003

(30) Foreign Application Priority Data
Sep. 26, 2002 (JP) P2002-281472

(51) Int. Cl. G02B 6/255

(52) U.S. Cl. 385/96

(57) ABSTRACT

The present invention relates to a fabrication method of an optical fiber product and others capable of effectively restraining increase of loss near the wavelength of 1.38 μm induced by OH-radical absorption. The fabrication method of the optical fiber product involves the steps of preparing two optical fibers with mutually different mode field diameters, and heating a region near a splice end face of at least one optical fiber with the smaller mode field diameter by a heating source not using a fuel containing pure hydrogen as a constitutive element, before or after a fusion splice is made between these optical fibers. This reduces the OH-radical absorption in the heated region, so as to decrease the increase of transmission loss at the wavelength of 1.38 μm to 0.1 dB or less.

### BACKGROUND OF THE INVENTION

1. Field of the Invention

The present invention relates to an optical fiber product applicable to WDM (Wavelength Division Multiplexing) optical communication systems for transmitting signal light of multiple channels of mutually different wavelengths, and a fabrication method thereof, a Raman amplifier and a fabrication method thereof, a fabrication method of an optical coupler, and an optical transmission line.

2. Related Background Art

As a method of connecting between optical fibers of a different kind, the techniques disclosed in Document 1 “Development of New Optical Fusion Splicer for Factory Use”, IWCS, p. 644, and Document 2 “OH absorption-induced loss in tapered single-mode optical fiber”, ELECTRONICS LETTERS Feb. 28, 2002 Vol. 38 No. 5 pp.214-215 are known, for example.

The above Document 1 discloses a method of fusion-splicing between optical fibers of a different kind by an arc discharge. The connecting method of Document 1 can realize a low-loss connection by carrying out discharge-heating two or more times.

On the other hand, the above Document 2 discloses a method of heating optical fibers by a mixed burning of a gas including oxygen and normal hydrogen (hereinafter referred to as pure hydrogen).

### SUMMARY OF THE INVENTION

The Inventors conducted research on the conventional fabrication methods of optical fiber products and found the following problem. Namely, the arc discharge disclosed in Document 1 can not sufficiently reduce a connection loss because a heating width along a longitudinal direction of the optical fiber is small. On the other hand, as also described in above Document 2, the mixed burning of the gas containing oxygen and hydrogen results in increasing loss near the wavelength of 1.38 μm due to OH-radical absorption.

The present invention has been accomplished in order to solve the problem as discussed above and an object of the invention is to provide an optical fiber product and a fabrication method thereof, a Raman amplifier and a fabrication method thereof, a fabrication method of an optical coupler, and an optical transmission line, while effectively restraining the increase of loss near the wavelength of 1.38 μm due to the OH-radical absorption.

A method of fabricating an optical fiber product according to the present invention, comprises the first step of preparing an optical fiber as an object to be heated. This optical fiber is an optical transmission medium for transmitting light in a band (1370 nm-1410 nm) including the wavelength of 1.38 μm, and has a predetermined mode field diameter. The fabrication method of the optical fiber product expands the mode field diameter in a predetermined region of the prepared optical fiber. This expansion process of the mode field diameter is carried out by heating the predetermined region by means of a heating source not using a fuel containing pure hydrogen as a constitutive element so that an increase of transmission loss at the wavelength of 1.38 μm is 0.1 dB or less.

In some cases of fusion-splicing end faces of two optical fibers with mutually different mode field diameters, in order to reduce splice loss, an end portion of the fiber with the smaller mode field diameter is heated to expand the mode field diameter. In view of such fusion splicing between optical fibers, the fabrication method of the optical fiber product according to the present invention is also effectively applied to a case of preparing, together with the aforementioned optical fiber, another optical fiber to be connected to the optical fiber and fusion-splicing these two optical fibers. Particularly, in the case of such fusion splicing, the optical fiber with the smaller mode field diameter is heated in a predetermined region including a fused end face thereof, by means of a heating source not using a fuel containing pure hydrogen as a constitutive element, so that an increase of transmission loss at the wavelength of 1.38 μm is 0.1 dB or less. This heating of the predetermined region including the end face of the optical fiber is carried out before or after the fusion splicing of the two prepared fibers (with the mutually different mode field diameters).

As described above, the fabrication method of the optical fiber product according to the present invention involves the step of heating the predetermined region of the prepared optical fiber by means of the heating source not using the fuel containing pure hydrogen as a constitutive element, so as to expand the mode field diameter of the heated predetermined region. This heating process produces little H₂O. Therefore, it reduces the OH-radical absorption due to diffusion of H₂O in the optical fiber and thus effectively restrains the increase of loss near the wavelength of 1.38 μm induced by the OH-radical absorption.

In the fabrication method of the optical fiber product according to the present invention, the above heating source preferably comprises one of a torch for mixedly burning deuterium and oxygen, a heater (for example, an electric heater), and a laser (for example, a CO₂ laser). The reason is that the optical fiber can be surely heated without the use of the fuel containing pure hydrogen as a constitutive element. When deuterium is used, different from the case using pure hydrogen, the loss peak shifts to near the wavelength of 1.87 μm and causes no effect on optical communication in the band including the wavelength of 1.38 μm.

The optical fiber product obtained through the above steps (the optical fiber product according to the present invention) is applicable, for example, to various optical device components such as optical transmission lines, optical amplifiers including Raman amplifiers and other amplifiers, optical couplers, and so on. The optical fiber product according to the present invention includes an optical fiber for transmitting light in a band of a wavelength of 1.38 μm, and the end portion thereof is heated (expansion of mode field diameter). This heating process, as described above, uses a heating source using a fuel containing deuterium and oxygen, a CO₂ laser, and an electric heater, as a heating source not using a fuel containing pure hydrogen as a constitutive element. As a result, an increase of transmission loss at the wavelength of 1.38 μm is held down by 0.1 dB or less.

As an application example of the optical fiber product according to the present invention, an optical transmission line comprises a transmission optical fiber (first optical fiber) for transmitting light in a band including the wavelength of 1.38 μm, and an optical fiber (second optical fiber) fusion-spliced to the transmission optical fiber and having a mode field diameter different from that of the transmission optical fiber, wherein at least an end portion of the optical fiber with the smaller mode field diameter out of these optical fibers is one having been subjected to heating (expansion of the mode field diameter). This heating is implemented by means of a heating source using a fuel containing deuterium and oxygen, a CO₂ laser, and an electric heater, as a heating source not using a fuel containing pure hydrogen as a constitutive element, as described above, so that a splice between these optical fibers can be made without increasing the connection loss between these optical fibers while controlling the increase of transmission loss at the wavelength of 1.38 μm to 0.1 dB or less.

As an application example of the optical fiber product according to the present invention, a Raman amplifier comprises a pumping light source for supplying pumping light for Raman amplification, and a Raman-amplification optical fiber for Raman-amplifying signal light with supply of the pumping light. The Raman amplifier is a distributed Raman amplifier using a transmission-line fiber as a Raman-amplification optical fiber, or a lumped Raman amplifier provided with a Raman-amplification optical fiber separately from the transmission-line fiber. The Raman amplifier according to the present invention has a structure applicable to either of these distributed Raman amplifier and lumped Raman amplifier. Namely, a Raman amplifier according to the present invention comprises a Raman-amplification optical fiber constituting part of a transmission line for transmitting light in a band including the wavelength of 1.38 μm, an internal fiber element to be fusion-spliced to the Raman-amplification optical fiber, in which Raman-amplification pumping light propagates, and a pumping light supply for supplying the pumping light for Raman amplification of one or more channels having mutually different wavelengths into the inner optical fiber element. The Raman-amplification optical fiber and the internal fiber element have their respective mode field diameters different from each other. A fabrication method of this Raman amplifier according to the present invention comprises a step of heating a predetermined region including at least a fused end face of the component with the smaller mode field diameter out of these Raman-amplification optical fiber and interior optical fiber element, by means of a heating source not using a fuel containing pure hydrogen as a constitutive element, so that an increase of transmission loss at the wavelength of 1.38 μm is 0.1 dB or less. In this case, the above heating source comprises one of a torch for mixedly burning deuterium and oxygen, a heater, and a laser. The heating of the predetermined region including the fused end face may be carried out at timing of either before or after the fusion splicing between the Raman-amplification optical fiber and the internal fiber element.

Particularly, when the Raman amplifier according to the present invention is a distributed Raman amplifier, the Raman amplifier includes a transmission-line fiber as the above Raman-amplification optical fiber, and the above internal fiber element corresponds to at least an optical fiber directly fusion-spliced to the transmission-line fiber; for example, a dispersion compensating fiber necessary for compensation for chromatic dispersion of the transmission line, or an optical fiber through which pumping light propagates. On the other hand, when the Raman amplifier according to the present invention is a lumped Raman amplifier, the Raman amplifier includes the above Raman-amplification optical fiber (which may include a dispersion compensating fiber for compensation for chromatic dispersion of the transmission line) prepared separately from the transmission-line fiber, and the internal fiber element corresponds to at least an optical fiber through which pumping light propagates and which is directly fusion-spliced to the Raman-amplification optical fiber.

As described above, the Raman amplifier comprising the optical fiber product obtained by the above fabrication method is yielded while effectively restraining the increase of loss near the wavelength of 1.38 μm induced by OH-radical absorption. Namely, when the end portion of the optical-amplification optical fiber is heated by the heating source not using the fuel containing pure hydrogen as a constitutive element, the heating process of the optical-amplification optical fiber produces little H₂O, so as to reduce the OH-radical absorption due to diffusion of H₂O into the optical-amplification optical fiber (or restrain the increase of loss near the wavelength of 1.38 μm induced by OH-radical absorption).

Furthermore, as an application example of the optical fiber product according to the present invention, an optical coupler can be obtained by heating and fusing side faces of two optical fibers by the above-stated heating (the fabrication method of the optical fiber product according to the present invention). In this case, the two optical fibers are also heated by the torch for mixedly burning deuterium and oxygen or the like, so that the heating process of these optical fibers produces little H₂O. Therefore, it reduces the OH-radical absorption due to diffusion of H₂O into the optical fibers, so as to restrain the increase of loss near the wavelength of 1.38 μm induced by OH-radical absorption.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a diagram showing a configuration of lumped Raman amplifier as a first embodiment of the Raman amplifier according to the present invention (including the optical fiber product according to the present invention);

FIG. 2 is a diagram showing a sectional structure of an optical-transmission optical fiber (or an optical fiber for introduction of pumping light) and an optical-amplification optical fiber shown in FIG. 1 (i.e., a sectional structure of the optical fiber product according to the present invention);

FIGS. 3A-3C are diagrams showing various configurations of distributed Raman amplifiers as a second embodiment of the Raman amplifier according to the present invention (including the optical fiber product according to the present invention);

FIGS. 4A-4C are diagrams for explaining a splice step between the optical-transmission optical fiber (or the optical fiber for introduction of pumping light) and the optical-amplification optical fiber shown in FIG. 2 (the fabrication method of the optical fiber product according to the present invention);

FIG. 5 is a graph showing changes of splice loss under various heating conditions for optical fibers; and

FIG. 6 is a diagram for explaining a fabrication method of the optical coupler shown in FIG. 1 (the fabrication method of the optical coupler according to the present invention).

### DETAILED DESCRIPTION OF THE PREFERRED EMBODIMENTS

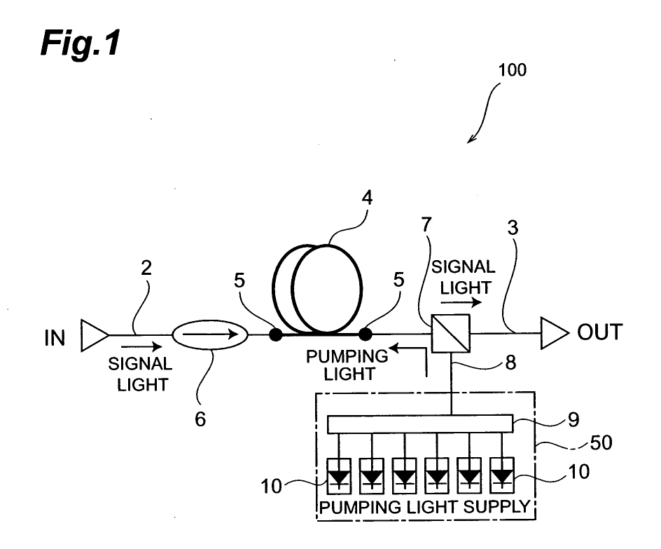

Embodiments of the optical fiber product and fabrication method thereof, the Raman amplifier and fabrication method thereof, the fabrication method of the optical coupler, and the optical transmission line will be described below in detail with reference to FIGS. 1, 2, 3A-4C, 5, and 6. The same components or same parts will be denoted by the same reference symbols throughout the description of the drawings, without redundant description thereof.

The wavelength band near the wavelength of 1.38 μm corresponds to the wavelength band of pumping light for Raman amplification in WDM (Wavelength Division Multiplexing) transmission of S-band (1460 nm-1530 nm), and therefore the loss increase in the wavelength band reduces a Raman amplification coefficient. The present invention, at the time of connecting between optical fibers having different mode field diameters, can realize a low loss connection without increasing a loss near the wavelength of 1.38 μm.

In the case of connecting optical fibers having different mode field diameters, a method of expanding mode field diameter of one of these optical fibers, which heats a fusion-spliced portion after fusion-splicing these optical fibers, is known before. However, in the heating using a gas containing oxygen and hydrogen, or a gas generating these, H₂O generated in the burning process diffuses into the heated optical fiber, and thereby a loss increases in the absorption band of OH-radical. The present invention can expand a mode field diameter without using a gas containing oxygen and hydrogen, or a gas generating these.

Specifically, the expansion mode field diameter carried out in this invention heats an optical fiber by a heating source such as a heating source using a fuel containing deuterium and oxygen, a heating source using a CO₂ laser, and a heating source using an electric heater. In particular, the heating of the heating source using the fuel containing deuterium and oxygen does not affect optical communications because the absorption band of OH-radical has a peak at the wavelength of 1.87 μm. For example, the heating using the fuel containing deuterium and oxygen is carried out by generating flame by using deuterium and oxygen obtained from an electrolysis of D₂O, and thereafter by heating the optical fiber with this flame.

FIG. 1 is a diagram showing a configuration of a lumped Raman amplifier as a first embodiment of the Raman amplifier according to the present invention. In FIG. 1, the Raman amplifier 100 is used in a WDM (Wavelength Division Multiplexing) transmission system of the S-band (1460 nm-1530 nm).

The Raman amplifier 100 is comprised of an optical transmission fiber 2 (internal fiber element), a Raman-amplification optical fiber 4, and a transmission-line fiber 3 (internal fiber element), which are arranged in order from an input end toward an output end, and the fibers are fusion-spliced at connection point 5 between the transmission-line fiber 2 and the Raman-amplification optical fiber 4 and at connection point 5 between the Raman-amplification optical fiber 4 and the transmission-line fiber 3. In this Raman amplifier 100, the optical fiber product according to the present invention is constructed of the combination of the Raman-amplification optical fiber 4 and the transmission-line fiber 3 being fusion-spliced to each other and letting pumping light pass through the connection point 5. In addition, the optical coupler according to the present invention is comprised of a combination of the transmission-line fiber 3 with an optical fiber 8 for introduction of pumping light.

An optical isolator 6 is located on the transmission-line fiber 2, and the optical coupler 7 for guiding the pumping light from a pumping light supply 50 through the pumping-light-introducing optical fiber (internal fiber element) 8 to the Raman-amplification optical fiber is located on the transmission-line fiber 3. The pumping light supply 50 is provided with a plurality of pumping light sources 10 prepared for respective pumping channels to be supplied, and an optical multiplexer 9 for multiplexing the pumping channels outputted from these pumping light sources 10. The Raman-amplification optical fiber 4 Raman-amplifies signal light (including multiple signal channels of mutually different wavelengths) having passed through the transmission-line fiber 2, with supply of the pumping light (including the multiple pumping channels of mutually different wavelengths) from the above pumping light supply 50 and outputs the amplified signal light to the transmission-line fiber 3.

The Raman amplifier 100 of FIG. 1 was described as a lumped Raman amplifier having the structure as described above, but it may be a distributed Raman amplifier using the optical fiber transmission line located in a transmission-line interval from an optical transmitter to an optical receiver, as a Raman-amplification optical fiber. In this case, the optical fiber product according to the present invention is comprised of a combination of the optical fiber transmission line functioning as a Raman-amplification optical fiber, with the pumping-light-introducing optical fiber (or the transmission-line fiber as an internal fiber element), in which the pumping light propagates through the fusion splice point.

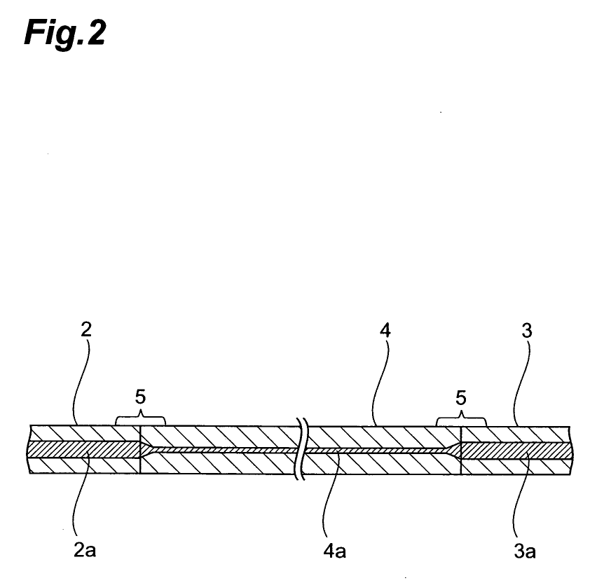

As shown in FIG. 2, the diameter (the mode field diameter) of core 4a of the Raman-amplification optical fiber 4 is smaller than those of cores 2a, 3a of the transmission-line optical fibers 2, 3. For this reason, the power density of propagating light increases so as to implement efficient Raman amplification. The fusion splice portions 5 between the transmission-line fibers 2, 3 and the Raman-amplification optical fiber 4 are portions having been subjected to such expansion of the mode field diameter as to increase the diameter of core 4a of the Raman-amplification optical fiber 4 in a taper shape up to the level approximately equal to the diameters of the cores 2a, 3a of the transmission-line fibers 2, 3, in order to decrease the splice loss of the optical fibers.

The optical isolator 6 for letting light pass only in the direction toward the Raman-amplification optical fiber 4 is placed on the transmission-line fiber 2. The optical coupler 7 is placed on the transmission-line fiber 3. The optical multiplexer 9 is connected through the pumping-light-introducing optical fiber 8 to the optical coupler 7, and the plurality of pumping light sources 10 are connected to this optical multiplexer 9.

These pumping light sources 10 output a plurality of pumping channels for Raman amplification of signal light. One of the pumping light sources 10 generates, for example, light in the 1.38 μm wavelength band (pumping channel). The optical multiplexer 9 multiplexes the multiple pumping channels outputted from these pumping light sources 10. The multiplexed light outputted from this optical multiplexer 9, i.e., the pumping light containing the multiple pumping channels of mutually different wavelengths is guided through the pumping-light-introducing optical fiber 8 to the optical coupler 7. The optical coupler 7 allows the signal light from the Raman-amplification optical fiber 4 to pass, and supplies the pumping light from the optical multiplexer 9 into the Raman-amplification optical fiber 4.

In the Raman amplifier 100 of the configuration as described above, the pumping channels of the respective wavelength bands outputted from the plurality of pumping light sources 10 are multiplexed in the optical multiplexer 9, and the pumping light from this optical multiplexer 9 is supplied through the optical coupler 7 into the Raman-amplification optical fiber 4. On the other hand, the signal light having passed through the transmission-line fiber 2 is Raman-amplified in the Raman-amplification optical fiber 4 with supply of the pumping light, and this Raman-amplified light is outputted through the optical coupler 7.

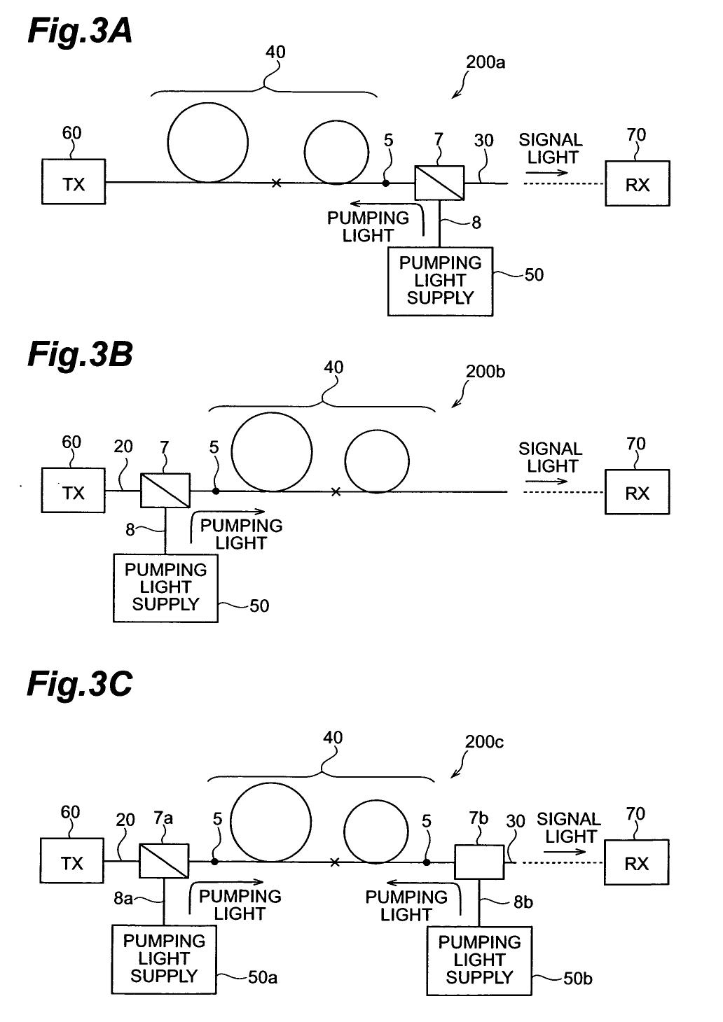

FIGS. 3A-3C are diagrams showing various configurations of distributed Raman amplifiers as a second embodiment of the Raman amplifier according to the present invention (including the optical fiber product according to the present invention). In particular, FIG. 3A shows a distributed Raman amplifier 200a carrying out Raman amplification by a backward pumping, FIG. 3B shows a distributed Raman amplifier 200b carrying out Raman amplification by a forward pumping, and FIG. 3C shows a distributed Raman amplifier 200c carrying out Raman amplification by a bi-directional pumping.

The Raman amplifier 200a shown in FIG. 3A is comprised of an optical fiber transmission line 40 functioning as a Raman amplification optical fiber and a transmission-line fiber 30 (at least a part corresponds to an internal fiber element), which are arranged in order from a transmitter TX 60 toward a receiver RX 70, and the fibers are fusion-spliced at connection point 5 between the optical transmission line 40 and the transmission-line fiber 30. In this Raman amplifier 200a, the optical fiber product according to the present invention is constructed of the combination of the optical transmission line 40 and the transmission-line fiber 30 being fusion-spliced to each other and letting pumping light pass through the connection point 5. In addition, the optical coupler according to the present invention is comprised of a combination of the transmission-line fiber 30 with a pumping-light-introducing optical fiber 8. In FIG. 3A, the symbol “X” indicates a fusion-spliced point.

The optical coupler 7 for guiding the pumping light from a pumping light supply 50 through the pumping-light-introducing optical fiber (internal fiber element) 8 into the optical transmission line 40 is located on the transmission-line fiber 30 (backward pumping). The pumping light supply 50 has a same structure as the Raman amplifier 100 according to the first embodiment shown in FIG. 1, and is provided with a plurality of pumping light sources prepared for respective pumping channels to be supplied, and an optical multiplexer for multiplexing the pumping channels outputted from these pumping light sources. The optical transmission line 40 Raman-amplifies signal light (including multiple signal channels of mutually different wavelengths) propagating therethrough, with supply of the pumping light (including the multiple pumping channels of mutually different wavelengths) from the above pumping light supply 50 and outputs the amplified signal light to the transmission-line fiber 30.

The Raman amplifier 200b shown in FIG. 3B is comprised of a transmission-line fiber 20 (at least a part corresponds to an internal fiber element) and an optical transmission line 40 functioning as a Raman amplification optical fiber, which are arranged in order from a transmitter TX 60 toward a receiver RX 70, and the fibers are fusion-spliced at connection point 5 between the transmission-line fiber 20 and the optical transmission line 40. In this Raman amplifier 200b, the optical fiber product according to the present invention is constructed of the combination of the transmission-line-fiber 20 and the optical transmission line 40 being fusion-spliced to each other and letting pumping light pass through the connection point 5. In addition, the optical coupler according to the present invention is comprised of a combination of the transmission-line fiber 20 with a pumping-light-introducing optical fiber 8. In FIG. 3B, the symbol “X” indicates a fusion-spliced point.

The optical coupler 7 for guiding the pumping light from a pumping light supply 50 through the pumping-light-introducing optical fiber (internal fiber element) 8 into the optical transmission line 40 is located on the transmission-line fiber 20 (forward pumping). The pumping light supply 50 has a same structure as the Raman amplifier 100 according to the first embodiment shown in FIG. 1, and is provided with a plurality of pumping light sources prepared for respective pumping channels to be supplied, and an optical multiplexer for multiplexing the pumping channels outputted from these pumping light sources. The optical transmission line 40 Raman-amplifies signal light (including multiple signal channels of mutually different wavelengths) propagating therethrough, with supply of the pumping light (including the multiple pumping channels of mutually different wavelengths) from the above pumping light supply 50.

The Raman amplifier 200c shown in FIG. 3C is comprised of a transmission-line fiber 20 (at least a part corresponds to an internal fiber element), an optical transmission line 40 functioning as a Raman amplification optical fiber, and a transmission-line fiber 30 (at least a part corresponds to an internal fiber element), which are arranged in order from a transmitter TX 60 toward a receiver RX 70, and the fibers are fusion-spliced at connection point 5 between the transmission-line fiber 20 and the optical transmission line 40, and connection point 5 between the optical transmission line 40 and the transmission-line fiber 30. In this Raman amplifier 200c, the optical fiber product according to the present invention is constructed of the combination of the transmission-line-fiber 20 and the optical transmission line 40 and the combination of the optical transmission line 40 and the transmission-line fiber 30, being fusion-spliced to each other and letting pumping light pass through the connection point 5. In addition, the optical coupler according to the present invention is comprised of a combination of the transmission-line fiber 20 with a pumping-light-introducing optical fiber 8a and a combination of the transmission-line fiber 30 with a pumping-light-introducing optical fiber 8b. In FIG. 3C, the symbol “X” indicates a fusion-spliced point.

The optical coupler 7a for guiding the pumping light from a pumping light supply 50a through the pumping-light-introducing optical fiber (internal fiber element) 8a into the optical transmission line 40 is located on the transmission-line fiber 20, and the optical coupler 7b for guiding the pumping light from a pumping light supply 50b through the pumping-light-introducing optical fiber (internal fiber element) 8b into the optical transmission line 40 is located on the transmission-line fiber 30 (bi-directional pumping). Each of the pumping light supply 50a and the pumping light supply 50b has a same structure as the Raman amplifier 100 according to the first embodiment shown in FIG. 1, and is provided with a plurality of pumping light sources prepared for respective pumping channels to be supplied, and an optical multiplexer for multiplexing the pumping channels outputted from these pumping light sources. The optical transmission line 40 Raman-amplifies signal light (including multiple signal channels of mutually different wavelengths) propagating therethrough, with supply of the pumping light (including the multiple pumping channels of mutually different wavelengths) from the above pumping light supply 50a and the pumping light from the above pumping light supply 50b.

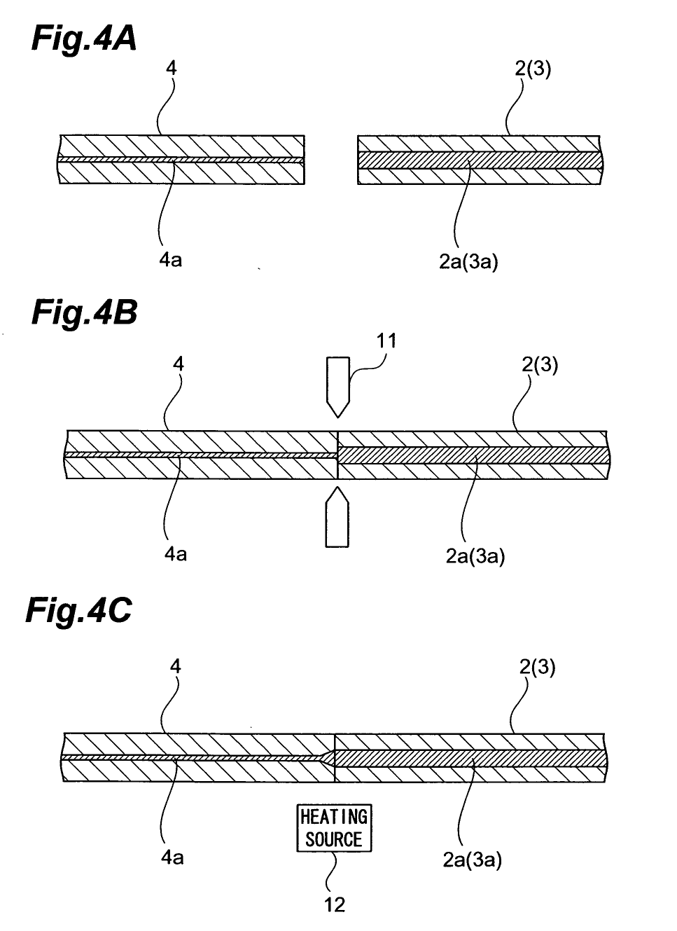

A fabrication method of the above Raman amplifier 100 (including the fabrication method of the optical fiber product according to the present invention) will be described below using FIGS. 4A-4C. Particularly, the description below will concern a step of splicing the transmission-line fibers 2, 3 to the Raman-amplification optical fiber 4.

First, as shown in FIG. 4A, an end face of the transmission-line fiber 2 or 3 is made to butt against an end face of the Raman-amplification optical fiber 4. In that state, arc discharge is induced by discharger 11 of a fusion splicer to make a fusion splice between the end face of transmission-line fiber 2 or 3 and the end face of Raman-amplification optical fiber 4 (FIG. 4B).

Subsequently, as shown in FIG. 4C, the both end portions (predetermined regions including the end faces) of the Raman-amplification optical fiber 4 are heated by heating source 12 to expand the diameter of core 4a of the Raman-amplification optical fiber 4 (expansion of the mode field diameter). At this time, the expansion of the mode field diameter of the Raman-amplification optical fiber 4 is carried out, for example, while injecting light into one end of the transmission-line fiber 2 fusion-spliced and monitoring the optical power of output light from the transmission-line fiber 3 located on the other side.

The heating source 12 is preferably a torch for mixedly burning deuterium (D₂) and oxygen, for example. At this time, heavy water (D₂O) may be decomposed by electrolysis to generate deuterium and oxygen, and flame may be made by use of them; or deuterium and oxygen may be prepared separately.

The fabrication method of FIGS. 4A-4C is applicable to those of distributed Raman amplifiers respectively shown in FIGS. 3A-3C. In this case, the Raman-amplification optical fiber 4 in the lumped Raman amplifier 100 corresponds to the optical transmission line 40 in the distributed Raman amplifiers 200a-200c, and the transmission-line fibers 2 and 3 correspond to the transmission-line fibers 20 and 30.

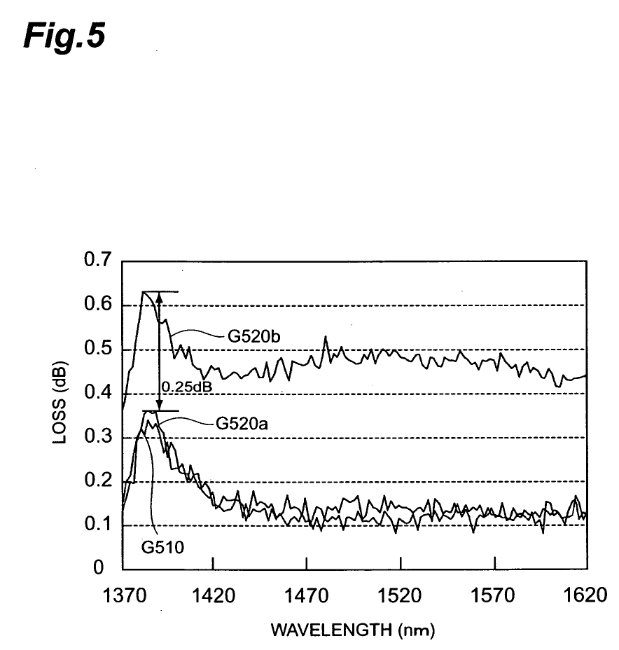

Incidentally, if the optical fibers are heated by mixed burning of oxygen with a gas containing normal hydrogen (pure hydrogen) different from deuterium (e.g., pure hydrogen itself, or an organic fuel such as methane, propane, or the like), H₂O evolved in the burning step will diffuse into the interior of the optical fibers, so as to increase the loss in the 1.38 μm wavelength band being the OH-radical absorption band, as shown in FIG. 5. FIG. 5 shows three characteristics under different heating conditions. In FIG. 5, graph G510 represents a loss characteristic of the optical fiber before the heating process, graph G520a a loss characteristic of the optical fiber heated by a torch for mixedly burning oxygen and a gas containing normal hydrogen (pure hydrogen) different from deuterium (e.g., pure hydrogen itself, or an organic fuel such as methane, propane, or the like), and graph G520b a loss characteristic of the optical fiber heated by a torch for mixedly burning deuterium (D₂) and oxygen.

As seen from this FIG. 4, the 1.38 μm wavelength band agrees with the wavelength band of the Raman-amplification pumping light in the S-band (1460 nm-1530 nm) WDM (Wavelength Division Multiplexing) transmission, so that the increase of loss in the 1.38 μm wavelength band lowers the Raman amplification efficiency eventually.

On the other hand, the fabrication method of the optical fiber product according to the present invention involves the heating of the end portion of the Raman-amplification optical fiber 4 by the torch for mixedly burning deuterium and oxygen, which produces little H₂ and H₂O during the burning heating. This reduces the OH-radical absorption-induced loss (absorption loss) in the 1.38 μm wavelength band. Accordingly, the signal light is effectively Raman-amplified in the Raman amplifiers 100 and 200a-200c. Since the loss induced by OH-radical absorption has a peak near the wavelength of 1.87 μm, it presents no effect on optical communication in the 1.38 μm wavelength band.

The heating source 12 may also be a laser such as a CO₂ laser or the like, or a heater such as an electric heater or the like, in addition to the torch for mixedly burning deuterium and oxygen. These heating sources 12 do not use the fuel containing pure hydrogen as a constitutive element, either, and thus produce neither H₂ nor H₂O during the burning process, so as to surely reduce the absorption loss in the 1.38 μm wavelength band.

The splice step between the transmission-line fibers 2, 3 and the Raman-amplification optical fiber 4 may also be modified in such a way that the both end portions of the Raman-amplification optical fiber 4 are first heated by the heating source 12 to expand the mode field diameter at the both end portions of the Raman-amplification optical fiber 4 and that thereafter each of the transmission-line fibers 2, 3 is fusion-spliced to the Raman-amplification optical fiber 4.

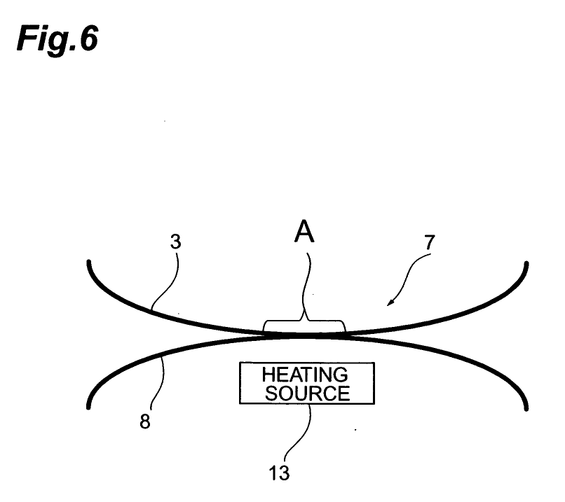

For forming the optical coupler 7, as shown in FIG. 6, in the region A, the transmission-line fiber 3 and the pumping-light-introducing optical fiber 8 are fused by melting and drawing them by the heating source 13. The heating source 13 used herein is the torch for mixedly burning deuterium and oxygen as described above. In this case, therefore, little H₂O is produced during the heating of the optical fibers 3, 8, so as to reduce the loss induced OH-radical absorption in the 1.38 μm wavelength band. The fabrication method of coupler shown in FIG. 6 is applicable to those of couplers 7, 7a and 7b shown in FIGS. 3A-3C. In this case, the transmission-line fibers 2 and 3 in the lumped Raman amplifier 100 respectively correspond to the transmission-line fibers 20 and 30 in the distributed Raman amplifiers 200a-200c, and the pumping-light-introducing optical fiber 8 corresponds to the pumping-light-introducing optical fibers 8, 8a and 8b in the distributed Raman amplifiers 200a-200c, respectively.

It is noted that the present invention is by no means intended to be limited to the above embodiments. Namely, the heating of the optical fiber with the torch for mixedly burning deuterium and oxygen is also applicable to cases of heating an optical fiber immediately after drawn in the fabrication process of optical fiber, as well as cases of expanding the mode field diameter of optical fiber and cases of fabricating the optical coupler.

As described above, the present invention involves the heating of the predetermined region of the optical fiber by the heating source not using the fuel containing pure hydrogen as a constitutive element, for example, by the torch for mixedly burning deuterium and oxygen or the like, which effectively restrains the increase of loss near the wavelength of 1.38 μm induced by OH-radical absorption.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of fabricating an optical fiber product, comprising the steps of:
preparing a first optical fiber for transmitting light in a band including a wavelength of 1.38 μm, said first optical fiber having a predetermined mode field diameter; and
expanding the mode field diameter in a predetermined region of said first optical fiber,
wherein the predetermined region is heated by a heating source not using a fuel containing pure hydrogen as a constitutive element, so that an increase of transmission loss at the wavelength of 1.38 μm is 0.1 dB or less.

2. A method according to claim 1, wherein said heating source comprises one selected from a torch for mixedly burning deuterium and oxygen, a heater, and a laser.

3. A method according to claim 1, further comprising the steps of:
preparing a second optical fiber having a mode field diameter larger than that of said first optical fiber; and
fusion-splicing an end face of said first optical fiber to an end face of said second optical fiber,
wherein the predetermined region heated includes the end face of said first optical fiber, and
wherein the predetermined region is heated before or after the fusion-splicing of said first and second optical fibers.

4. A method of fabricating a Raman amplifier, comprising the steps of:
preparing a Raman-amplification optical fiber constituting part of a transmission line for transmitting light in a band including a wavelength of 1.38 μm, said Raman-amplification optical fiber having a predetermined mode field diameter;
preparing an internal fiber element to be fusion-spliced to said Raman-amplification optical fiber, through which pumping light for Raman amplification propagates, said internal fiber element having a mode field diameter different from that of said Raman-amplification optical fiber; and
heating a predetermined region including at least a fused end face of one with the smaller mode field diameter out of said Raman-amplification optical fiber and said internal fiber element, by means of a heating source not using a fuel containing pure hydrogen as a constitutive element, so that an increase of transmission loss at the wavelength of 1.38 μm is 0.1 dB or less.

5. A method according to claim 4, wherein said heating source comprises one selected from a torch for mixedly burning deuterium and oxygen, a heater, and a laser.

6. A method according to claim 4, wherein the heating of the predetermined region including the fused end face is carried out before or after a fusion splice is made between said Raman-amplification optical fiber and said internal fiber element.

7. A Raman amplifier, comprising:
a Raman-amplification optical fiber constituting part of a transmission line for transmitting light in a band including a wavelength of 1.38 μm, said Raman-amplification optical fiber having a predetermined mode field diameter; and
an internal fiber element to be fusion-spliced to said Raman-amplification optical fiber, through which pumping light for Raman amplification propagates, said internal fiber element having a mode field diameter different from that of said Raman-amplification optical fiber,
wherein a predetermined region, which includes at least a fused end face of one with the smaller mode field diameter out of said Raman-amplification optical fiber and said internal fiber element, has been heated by a heating source not using a fuel containing pure hydrogen as a constitutive element, so that an increase of transmission loss at the wavelength of 1.38 μm was 0.1 dB or less.

8. A Raman amplifier according to claim 7, further comprising a pumping light supply for supplying the pumping light for Raman amplification into said inner optical fiber element.

9. A method of fabricating an optical coupler, comprising the steps of:
preparing a first optical fiber and a second optical fiber; and
fusion-splicing a side face of said first optical fiber to a side face of said second optical fiber,
wherein the fusion-splicing is implemented by heating the side faces of said first and second optical fibers by a heating source not using a fuel containing pure hydrogen as a constitutive element, so that an increase of transmission loss at a wavelength of 1.38 μm is 0.1 dB or less.

10. A method according to claim 10, wherein said heating source comprises one selected from a torch for mixedly burning deuterium and oxygen, a heater, and a laser.

11. An optical fiber product, said optical fiber product including an optical fiber which transmits light in a band including a wavelength of 1.38 μm and which has a predetermined mode field diameter,
wherein a predetermined region including an end face of said optical fiber has been heated by a heating source not using a fuel containing pure hydrogen as a constitutive element to expand the mode field diameter of said predetermined region, so that an increase of transmission loss at the wavelength of 1.38 μm was 0.1 dB or less.

12. An optical fiber product, said optical fiber product including an optical fiber which transmits light in a band including a wavelength of 1.38 μm and which has a predetermined mode field diameter,
wherein a predetermined region including an end face of said optical fiber has been heated by a heating source using a fuel containing deuterium and oxygen as a constitutive element to expand the mode field diameter of said predetermined region, so that an increase of transmission loss at the wavelength of 1.38 μm was 0.1 dB or less.

13. An optical fiber product, said optical fiber product including an optical fiber which transmits light in a band including a wavelength of 1.38 μm and which has a predetermined mode field diameter,
wherein a predetermined region including an end face of said optical fiber has been heated by a heating source using a CO₂ laser to expand the mode field diameter of said predetermined region, so that an increase of transmission loss at the wavelength of 1.38 μm was 0.1 dB or less.

14. An optical fiber product, said optical fiber product including an optical fiber which transmits light in a band including a wavelength of 1.38 μm and which has a predetermined mode field diameter,
wherein a predetermined region including an end face of said optical fiber has been heated by a heating source using an electric heater to expand the mode field diameter of said predetermined region, so that an increase of transmission loss at the wavelength of 1.38 μm was 0.1 dB or less.

15. An optical transmission line, comprising:
a first optical fiber for transmitting light in a band including a wavelength of 1.38 μm, said first optical fiber having a predetermined mode field diameter; and
a second optical fiber fusion-spliced to said first optical fiber and having a mode field diameter smaller than that of said first optical fiber, said second optical fiber having a predetermined region including an end face fusion-spliced to an end face of said first optical fiber,
wherein the predetermined region has been heated by a heating source not using a fuel containing pure hydrogen as a constitutive element, so that an increase of transmission loss at the wavelength of 1.38 μm was 0.1 dB or less.
